(19) United States
(12) Patent Application Publication
(10) Pub. No.: US 2016/0291441 A1
(43) Pub. Date: Oct. 6, 2016

(54) ELECTROPHORETIC DISPLAY DEVICE AND ELECTRONIC APPARATUS

(71) Applicant: Seiko Epson Corporation, Tokyo (JP)

(72) Inventor: Katsunori Yamazaki, Matsumoto-shi (JP)

(21) Appl. No.: 15/049,452

(22) Filed: Feb. 22, 2016

(30) Foreign Application Priority Data
Mar. 31, 2015 (JP) 2015-071560

(51) Int. Cl. G02F 1/167; G02F 1/1333

(52) U.S. Cl. CPC G02F 1/167; G02F 1/133377

(57) ABSTRACT

Provided is an electrophoretic display device in which a partitioning wall is provided between a first substrate and a second substrate, a dispersion liquid is disposed in a region that is partitioned by the partitioning wall, the dispersion liquid includes a dispersion medium and electrophoretic particles, and surfaces of partitioning wall on side of the region include inclined section, which is inclined with respect to a normal direction of the first substrate, and does not have a configuration in which the surfaces of the partitioning wall on the side of the region of portions that respectively correspond to all of a plurality of edges that intersecting lines between the surface of the partitioning wall on the side of the region and a surface of a first substrate side thereof, form, include inclined section with the same inclination direction and the same inclination angle.

### BACKGROUND

1. Technical Field

The present invention relates to an electrophoretic display device and electronic apparatus.

2. Related Art

Display devices that use electrophoresis (electrophoretic display devices) are known. Electrophoretic display devices include an electrophoretic layer between two substrates (in this instance, a pixel substrate and a counter substrate), which face one another, and perform display by moving charged particles (hereinafter, referred to as electrophoretic particles) that migrate in a dispersion medium (a solvent) which is present in the electrophoretic layer, using an electric field. The corresponding electric field is generated as a result of a potential difference being applied between the two substrates. In addition, among the two substrates, one surface (a surface of the counter substrate) forms a display surface. Electrophoretic display devices can be adopted in electronic apparatuses such as electronic paper. Electrophoretic display devices are also referred to as EPDs (Electrophoretic Displays).

The electrophoretic layer is partitioned into a plurality of regions (cells) by providing a partitioning wall between the two substrates. In the related art, as an example, the partitioning wall is formed in a normal direction with respect to a display surface (refer to JP-A-2011-237706). As another example, there are cases in which a partitioning wall that has different widths on the two substrate sides, is provided, and in this case, the partitioning wall includes a trapezoidal shape.

If a potential difference is applied between the two substrates, an electric field is generated in a normal direction of the corresponding two substrates, and the electrophoretic particles migrate through the dispersion medium in the corresponding normal direction (an electric field direction). For example, a color of the electrophoretic particles that migrate to a side of a transparent counter substrate forms a display color. As an example, in a case in which a first type of electrophoretic particles (for example, electrophoretic particles that correspond to white) and a second type of electrophoretic particles (for example, electrophoretic particles that correspond to black) are present in a dispersion medium, the electrophoretic particles of one type that are present on a side of a counter substrate fall to a side of a pixel substrate, and the electrophoretic particles of the other type that are present on the side of the pixel substrate rise to the side of the counter substrate.

In this case, there are cases in which a state in which each electrophoretic particle impacts in the normal direction, and in addition, the dispersion medium exerts an effect, and a movement direction of each electrophoretic particle is not established, arises, and this is a cause of optical response being slow.

FIG. 6 is a cross-sectional view that shows a schematic configuration of an electrophoretic display device 1001 in which partitioning walls are formed in a normal direction with respect to a substrate.

In the electrophoretic display device 1001, partitioning walls 1013 and 1014 are formed between a pixel substrate section 1011 and a counter substrate section 1012. The pixel substrate section 1011 is shown schematically, but includes a pixel substrate and a pixel electrode. The counter substrate section 1012 is shown schematically, but includes a counter substrate and a counter electrode. In addition, a dispersion medium and electrophoretic particles are disposed (for example, enclosed) in regions (cells) that are partitioned by the partitioning walls 1013 and 1014, which are formed between the pixel substrate section 1011 and the counter substrate section 1012.

In FIG. 6, an example of the flow of electrophoretic particles (for example, a first type of electrophoretic particles) inside a cell is shown. In the example of FIG. 6, the generation of flow (downward flow) in a direction toward a lower (vertically lower) side substrate (the pixel substrate 1011) from an upper (vertical upper) side substrate (the counter substrate 1012) is not established, and becomes turbulent as a result of mixing together with upward flow.

In this instance, a feature of a response time until a display color is shown in the display surface of the electrophoretic display device being long will be described in detail.

According to the research of the present inventors, if a large number of electrophoretic particles to some extent migrate to the electrophoretic layer, the dispersion medium is also drawn along and flows. When this occurs, for example, if the dispersion medium flows from the pixel substrate to the counter substrate, particles of the dispersion medium in the vicinity of the of the counter substrate are expelled.

However, since the structure of the cell and the electric field are symmetrical, for example, forces with which dispersion media in the vicinity of the counter substrate mutually interact oppose one another, and a state in which flow does not progress is generated. Further, if the equilibrium is lost for some reason, initially, an indefinite turbulence is generated.

A migration velocity of the electrophoretic particles is regulated by a terminal velocity by the viscosity of the dispersion medium. The corresponding terminal velocity is a relative velocity of the electrophoretic particles with respect to peripheral dispersion medium. For example, in a case in which the dispersion medium flows toward the top, a movement velocity of the electrophoretic particles in an upward direction is a velocity in which a flow velocity of the dispersion medium is added to the terminal velocity thereof.

That is, for example, in a case in which electrophoretic particles that rise are in a dispersion medium that rises, the movement velocity of the corresponding electrophoretic particles is fast, in a case in which the dispersion medium does not flow, the movement velocity of the corresponding electrophoretic particles is the terminal velocity thereof, and in a case in which electrophoretic particles that rise are in a dispersion medium that falls, the movement velocity of the corresponding electrophoretic particles is slow. Additionally, the same applies to electrophoretic particles that fall.

In this manner, in a circumstance until a loss of symmetry is generated, or alternatively, in a circumstance in which turbulence is generated and rising or falling of the dispersion medium is not established, smooth movement of the electrophoretic particles is interrupted. This causes the optical response to be slow.

In electrophoretic display devices of the related art, there are cases in which smooth movement of the electrophoretic particles is not realized in regions (cells) that are partitioned by partitioning walls formed between two substrates.

### SUMMARY

An advantage of some aspects of the invention is to provide an electrophoretic display device and an electronic apparatus that can realize smooth movement of electrophoretic particles in regions (cells) that are partitioned by partitioning walls formed between two substrates.

According to an aspect of the invention, there is provided an electrophoretic display device in which partitioning walls are provided between a first substrate and a second substrate, in which a dispersion liquid is disposed in regions that are partitioned by the partitioning walls, the dispersion liquid includes a dispersion medium and electrophoretic particles, and surfaces of partitioning walls on sides of the regions include inclined sections, which are inclined with respect to a normal direction of the first substrate, and do not have a configuration in which the surfaces of the partitioning walls on the sides of the regions of portions that respectively correspond to all of a plurality of edges that intersecting lines between the surfaces of the partitioning walls on the sides of the regions and surfaces of first substrate sides thereof, form, include inclined sections with the same inclination direction and the same inclination angle.

In this case, in the electrophoretic display device, the inclined sections promote smooth movement of the electrophoretic particles in the regions (cells). As a result of this, in the electrophoretic display device, it is possible to realize smooth movement of the electrophoretic particles in regions (cells) that are partitioned by partitioning walls formed between two substrates.

In the electrophoretic display device according to the aspect of the invention, a configuration in which the surfaces of the partitioning walls on the sides of the regions are not symmetrical when rotated by two or more different angles with respect to an axis of the normal direction of the first substrate, may be used.

In this case, in the electrophoretic display device, as a result of not being symmetrical in the abovementioned manner, the inclined sections promote smooth movement of the electrophoretic particles in the regions (cells). As a result of this, in the electrophoretic display device, it is possible to realize smooth movement of the electrophoretic particles in regions (cells) that are partitioned by partitioning walls formed between two substrates.

In the electrophoretic display device according to the aspect of the invention, a configuration in which the surfaces of the partitioning walls on the sides of the regions of portions that correspond to only a single edge among the plurality of edges that intersecting lines between the surfaces of the partitioning walls on the sides of the regions and the surfaces of first substrate sides thereof, form, include the inclined sections, may be used.

In this case, in the electrophoretic display device, the inclined sections promote smooth movement of the electrophoretic particles in the regions (cells). As a result of this, in the electrophoretic display device, it is possible to realize smooth movement of the electrophoretic particles in regions (cells) that are partitioned by partitioning walls formed between two substrates.

In the electrophoretic display device according to the aspect of the invention, a configuration in which the surfaces of the partitioning walls on the sides of the regions of portions that correspond to two mutually parallel edges among the plurality of edges that intersecting lines between the surfaces of the partitioning walls on the sides of the regions and the surfaces of first substrate sides thereof, form, both have a configuration that includes the inclined sections, and do not have a configuration in which the inclination directions of the inclined sections, which include the respective edges, with respect to surfaces that are parallel to the normal direction of the first substrate, are opposite, and the inclination angles thereof are the same, may be used.

In this case, in the electrophoretic display device, mutually asymmetrical inclined sections of partitioning walls of portions that correspond to the two edges promote smooth movement of the electrophoretic particles in the regions (cells). As a result of this, in the electrophoretic display device, it is possible to realize smooth movement of the electrophoretic particles in regions (cells) that are partitioned by partitioning walls formed between two substrates.

In the electrophoretic display device according to the aspect of the invention, a configuration in which the surfaces of the partitioning walls on the sides of the regions of portions that correspond to two mutually parallel edges among the plurality of edges, both have a configuration that includes the inclined sections, and have a configuration in which the inclination directions and inclination angles of the inclined sections, which include the respective edges, with respect to surfaces that are parallel to the normal direction of the first substrate, are the same, may be used.

In this case, in the electrophoretic display device, mutually asymmetrical inclined sections of partitioning walls that correspond to the two edges promote smooth movement of the electrophoretic particles in the regions (cells). As a result of this, in the electrophoretic display device, it is possible to realize smooth movement of the electrophoretic particles in regions (cells) that are partitioned by partitioning walls formed between two substrates.

In the electrophoretic display device according to the aspect of the invention, a configuration in which the plurality of edges form polygonal edges, may be used.

In this case, in the electrophoretic display device, the regions (cells) include polygonal surfaces. As a result of this, in the electrophoretic display device, in a case in which regions (cells) that include polygonal surfaces, are formed, it is possible to realize smooth movement of the electrophoretic particles in the corresponding regions (cells).

In the electrophoretic display device according to the aspect of the invention, a configuration in which the surfaces of the partitioning walls on the sides of the regions of portions that correspond to two mutually parallel edges among the plurality of edges, are flat surfaces, may be used.

In this case, in the electrophoretic display device, inner surfaces (surfaces on the sides of the regions (cells)) of the partitioning walls of portions that correspond to the two edges are flat surfaces. As a result of this, in the electrophoretic display device, it is possible to realize smooth movement of the electrophoretic particles in regions (cells) that are partitioned by partitioning walls formed between two substrates using a configuration that can be easily created.

In the electrophoretic display device according to the aspect of the invention, a configuration in which the surfaces of the partitioning walls on the sides of the regions of portions that correspond to two mutually parallel edges among the plurality of edges, are surfaces that include curved sections, may be used.

In this case, in the electrophoretic display device, the inner surfaces (the surfaces on the sides of the regions (cells)) of the partitioning walls of portions that correspond to the two edges are surfaces that include curved sections. As a result of this, in the electrophoretic display device, it is possible to realize smooth movement of the electrophoretic particles in regions (cells) that are partitioned by partitioning walls formed between two substrates using a configuration that can be easily created.

According to another aspect of the invention, there is provided an electronic apparatus that is provided with an electrophoretic display device such as that mentioned above.

In this case, in the electrophoretic display device in the electronic apparatus, the inclined sections promote smooth movement of the electrophoretic particles in the regions (cells). As a result of this, in the electrophoretic display device in the electronic apparatus, it is possible to realize smooth movement of the electrophoretic particles in regions (cells) that are partitioned by partitioning walls formed between two substrates.

In the abovementioned manner, according to the electrophoretic display device and the electronic apparatus of the aspects of the invention, in the electrophoretic display device, the inclined sections promote smooth movement of the electrophoretic particles in the regions (cells). As a result of this, in the electrophoretic display device and the electronic apparatus according to the aspects of the invention, in the electrophoretic display device, it is possible to realize smooth movement of the electrophoretic particles in regions (cells) that are partitioned by partitioning walls formed between two substrates.

### BRIEF DESCRIPTION OF THE DRAWINGS

The invention will be described with reference to the accompanying drawings, wherein like numbers reference like elements.

FIG. 1A is a cross-sectional view that shows a configuration example of an electrophoretic display device according to an embodiment (a first embodiment) of the invention, and FIG. 1B is a view that shows a configuration example of regions (cells).

FIG. 2 is a cross-sectional view that shows a schematic configuration example of the electrophoretic display device according to the embodiment (the first embodiment) of the invention.

FIG. 3 is a cross-sectional view that shows a schematic configuration example of an electrophoretic display device according to an embodiment (a second embodiment) of the invention.

FIG. 4 is a cross-sectional view that shows a schematic configuration example of an electrophoretic display device according to an embodiment (a third embodiment) of the invention.

FIGS. 5A to 5C are views that show schematic configuration examples of electronic apparatuses according to an embodiment (a fourth embodiment) of the invention.

FIG. 6 is a cross-sectional view that shows a schematic configuration of an electrophoretic display device in which partitioning walls are formed in a normal direction with respect to a substrate.

### DESCRIPTION OF EXEMPLARY EMBODIMENTS

Hereinafter, embodiments of the invention will be described in detail with reference to the drawings. Additionally, the drawings that are used are displayed enlarged or reduced as appropriate so that portions to be described are in states that are easily recognizable.

### First Embodiment

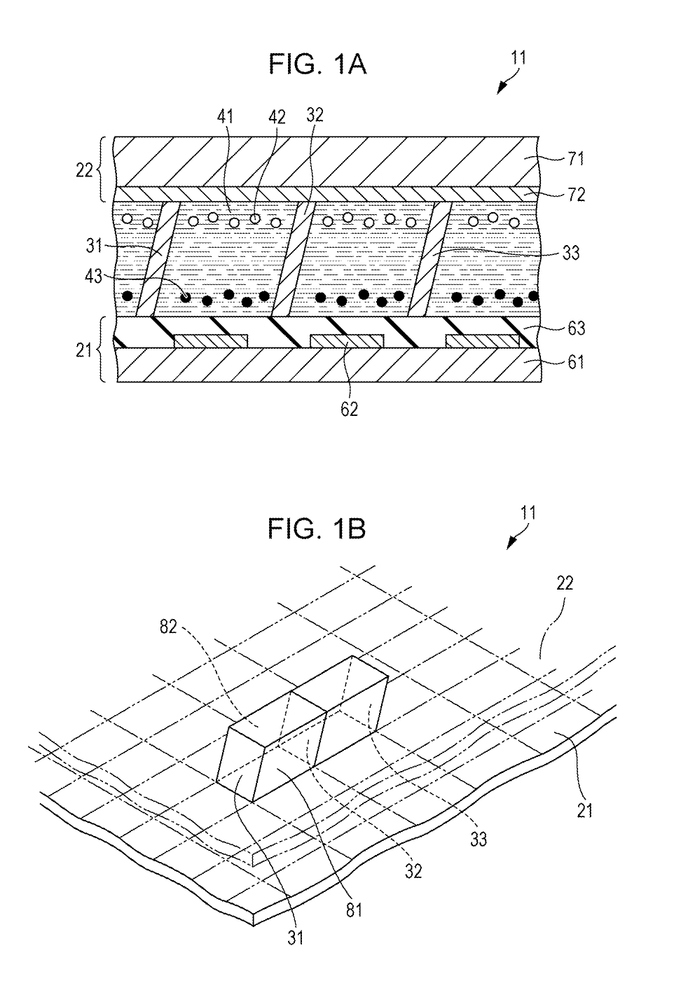

FIG. 1A is a cross-sectional view that shows a configuration example of an electrophoretic display device 11 according to an embodiment (a first embodiment) of the invention.

The electrophoretic display device 11 is provided with a pixel substrate section 21, a counter substrate section 22, partitioning walls 31, 32 and 33, a dispersion medium 41, a first type of electrophoretic particles (electrophoretic particles 42), and a second type of electrophoretic particles (electrophoretic particles 43). In the present embodiment, the first type of electrophoretic particles 42 are electrophoretic particles, which are negatively charged, and which correspond to white, and the second type of electrophoretic particles 43 are electrophoretic particles, which are positively charged, and which correspond to black. In addition, in the present embodiment, the two types of electrophoretic particles 42 and 43 are charged with loads in which positive and negative are opposite to one another. Additionally, the colors of the first type of particles and the second type of particles are not limited to the present example.

The pixel substrate section 21 is provided with a pixel substrate 61, a plurality of pixel electrodes 62, and an insulation layer 63.

The counter substrate section 22 is provided a counter substrate 71, and a counter electrode 72.

The pixel substrate 61 and the counter substrate 71 are disposed so as to face one another. The pixel substrate 61 and the counter substrate 71 are disposed so as to be parallel to one another. In the present embodiment, the pixel substrate 61 and the counter substrate 71 respectively have plate-shaped forms.

The pixel electrodes 62 are respectively formed on the pixel substrate 61, in each of a plurality of pixels on a side that faces the counter substrate 71, and the insulation layer 63 is also formed on the pixel substrate 61.

The counter electrode 72 is formed on the counter substrate 71, on a side that faces the pixel substrate 61. In the present embodiment, the counter electrode 72 is shared by the plurality of pixel electrodes 62. As another configuration example, a counter electrode 72, which is respectively divided for each of the plurality of pixel electrodes 62, may be provided.

A space that is interposed between the pixel substrate section 21 and the counter substrate section 22 is partitioned into a plurality of regions (cells) by a plurality of partitioning walls 31 to 33, which are provided between the pixel substrate section 21 and the counter substrate section 22. The dispersion medium 41, the first type of electrophoretic particles 42 and the second type of electrophoretic particles 43 are disposed (for example, enclosed) in each cell. The dispersion medium is configured from the dispersion medium 41 and the two types of electrophoretic particles 42 and 43. A layer of such a cell forms an electrophoretic layer.

FIG. 1B is a view that shows a configuration example of regions (cells).

In the present embodiment, for example, an inner section spatial portion that is partitioned by the partitioning wall 31, the partitioning wall 32, a partitioning wall 81, a partitioning wall 82, the pixel substrate section 21 and the counter substrate section 22 forms a single cell. Further, a plurality of cells that have the same shape are provided on the surface of the pixel substrate section 21 respectively lined up two directions (a horizontal direction and a vertical direction) that mutually intersect one another. In the present embodiment, a single cell has a rectangular (for example, a square or an oblong) shape on the surface of the pixel substrate section 21, and has a rectangular (for example, a square or an oblong) shape on the surface of the counter substrate section 22.

In addition, in the present embodiment, each partitioning wall 31 to 33, 81 and 82 has a plate-shaped form. In addition, the inner surface (a surface that faces an inner section of the cell) of each partitioning wall 31 to 33 includes an intersecting line between the corresponding surface and the pixel substrate section 21, and is inclined in the same inclination direction and at the same inclination angle with respect to a surface that is parallel to a normal direction of the pixel substrate section 21. In addition, the inner surface (a surface that faces the inner section of the cell) of each partitioning wall 81 and 82 is a surface that is parallel to the normal direction of the pixel substrate section 21.

Additionally, in the present embodiment, a surface of the pixel substrate 61, a surface of the pixel substrate section 21 (a surface of the insulation layer 63 in the present embodiment), a surface of the counter substrate 71, and a surface of the counter substrate section 22 (a surface of the counter electrode 72 in the present embodiment) are parallel to one another.

In the present embodiment, the electrophoretic display device 11 displays images on a side of the counter substrate 71 (a side that is opposite to the pixel substrate 61). A surface of a side of the counter substrate 71 forms a display surface.

In the electrophoretic display device 11, a potential difference between each pixel electrode 62 and the counter electrode 72 is controlled for each pixel electrode 62 by applying a voltage to the corresponding pixel electrode 62, and applying a voltage to the counter electrode 72 using a driving section (not illustrated in the drawing). Further, an electric field is generated in a normal direction of the pixel substrate 61 as a result of the corresponding potential difference.

In a case in which the potential of the counter electrode 72 is higher than that of a pixel electrode 62, for example, the first type of electrophoretic particles (the negatively-charged white particles) 42 move to a side of the counter electrode 72, and the second type of electrophoretic particles (the positively-charged black particles) 43 move to a side of the pixel electrode 62. Accordingly, white is displayed.

Meanwhile, in a case in which the potential of the counter electrode 72 is lower than that of a pixel electrode 62, for example, the first type of electrophoretic particles (the negatively-charged white particles) 42 move to a side of the pixel electrode 62, and the second type of electrophoretic particles (the positively-charged black particles) 43 move to a side of the counter electrode 72. Accordingly, black is displayed.

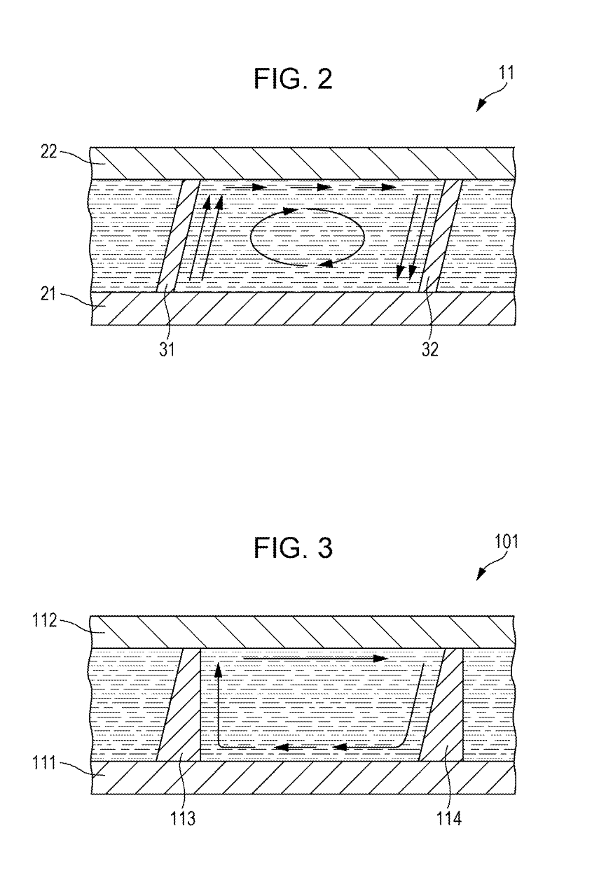

FIG. 2 is a cross-sectional view that shows a schematic configuration example of the electrophoretic display device 11 according to the embodiment (the first embodiment) of the invention.

In this instance, FIG. 2 outlines a cross-sectional view of the same electrophoretic display device 11 as that of FIG. 1A. Additionally, in FIG. 2, images of the flow of the dispersion liquid is shown clearly as a result of enlarging a crosswise direction.

In FIGS. 1A and 2, cross-sectional views in which a cell that is partitioned by the partitioning wall 31, the partitioning wall 32, and other partitioning walls 81 and 82, is shown with the corresponding partitioning wall 31 and the corresponding partitioning wall 32, which face one another, viewed from a lateral surface direction. In addition, images of the flow of the dispersion liquid are shown with arrows.

In the cross-sectional views of FIGS. 1A and 2, the partitioning wall 31 and the partitioning wall 32 are formed inclined in the same inclination direction and at the same inclination angle with respect to the normal direction of the pixel substrate section 21 (the normal direction of the pixel substrate 61).

In the configuration of such partitioning walls 31 and 32, if the cross-sectional view of FIG. 2 is taken as an example, in the electrophoretic layer, with respect to the dispersion medium 41, the first type of electrophoretic particles 42 and the second type of electrophoretic particles 43, a flow with rotation in a single direction is generated immediately, and a laminar flow is formed. In the example of FIG. 2, the corresponding flow with rotation in a single direction is an upward flow from bottom to top on a side of the partitioning wall 31, is a flow from left to right at a side of the surface of the counter electrode 72, and is a downward flow from top to bottom on a side of the partitioning wall 32.

More specifically, if an electrophoretic particle (in this instance, an electrophoretic particle 42 or an electrophoretic particle 43) migrates upward, the dispersion medium 41 also flows upward, but since the partitioning walls 31 and 32 are inclined, the dispersion medium 41 is fast in a crosswise direction. Therefore, as shown in FIG. 2, in a case in which the electrophoretic display device 11 is viewed in a cross-sectional manner, if an electric field is applied between the pixel electrodes 62 and the counter electrode 72, opposition to the force does not occur, and the dispersion medium 41 immediately flows in a manner in which the dispersion medium 41 rotates smoothly. Accordingly, the electrophoretic particles, which rise in the dispersion medium 41 that rises (or in other words, the electrophoretic particles that cause the dispersion medium 41 to rise), rise rapidly, and therefore, the response velocity is improved.

In this instance, the inclination angles of the partitioning walls 31 and 32 may be arbitrary, but since the velocity of the dispersion medium 41 and the electrophoretic particles 42 and 43 in the normal direction of the pixel substrate section 21 becomes slow if the inclination angles are too large, there are cases in which it is preferable that the inclination angles are not too large.

Additionally, even in a case in which two or more types of electrophoretic particles 42 and 43 having different polarities (charge polarities) are present, since the respective types of electrophoretic particles 42 and 43 determine the flow of the dispersion medium 41 depending on the respective movement amounts, concentrations and the like thereof, it is possible to obtain the same effect.

In the abovementioned manner, in the present embodiment, the partitioning walls 31 to 33, 81 and 82 are provided between a pair of substrates (the pixel substrate 61 and the counter substrate 71), in the electrophoretic display device 11, in which the dispersion liquid is disposed in regions (cells) that are partitioned by the partitioning walls 31 to 33, 81 and 82, the corresponding dispersion liquid includes the dispersion medium 41, and the electrophoretic particles 42 and 43, and the corresponding partitioning walls 31 to 33 are inclined in the same inclination direction with respect to the normal direction of the corresponding substrates. In addition, in the present embodiment, the corresponding partitioning walls 31 to 33 are inclined at the same angle.

In the electrophoretic display device 11 according to the present embodiment, as a result of the inclination of the partitioning walls 31 to 33, when the electrophoretic particles 42 and 43 move in an up-down direction, a velocity in the crosswise direction is attributed to the corresponding electrophoretic particles 42 and 43, which migrate in the up-down direction, or the dispersion medium 41, and therefore, it is possible to move the corresponding electrophoretic particles 42 and 43, or the dispersion medium 41 in the crosswise direction. As a result of this, it is possible to make a direction of flow (a flow direction of the dispersion medium 41) of the dispersion liquid, which is disposed in the cells in the inner section of the partitioning walls 31 to 33, 81 and 82, during image renewal (for example, when the voltage that is applied to the pixel electrodes 62 for each pixel is changed), a direction of flow (laminar flow) that rotates and moves in a single direction. Accordingly, for example, it is possible to improve the velocity of an optical response in comparison with the related art, and therefore, it is possible to increase the speed of the renewal of an image that is displayed.

In this manner, in the electrophoretic display device 11 according to the present embodiment, it is possible to realize smooth movement of the electrophoretic particles 42 and 43 in regions (cells) that are partitioned the partitioning walls 31 to 33, 81 and 82 formed between two substrates.

Additionally, as an example, it is possible to form the partitioning walls 31 to 33 by coating a substrate section (in the present embodiment, for example, the insulation layer 63 that is provided on the pixel substrate 61) with a photosensitive resin, placing a mask thereon, and exposing the substrate section with light in an oblique direction. This formation technique is easy to implement. In this instance, an azimuth of the exposure in the oblique direction may be arbitrary, and for example, may be a direction along a predetermined edge of the partitioning walls 31 to 33, or may be a direction along a diagonal line.

In addition, in a configuration such as that of the present embodiment in which the constituent elements (for example, the pixel electrode 62) of a single pixel are provided in a single cell, a high-speed response is possible, and it is possible to prevent bleeding between pixels. However, as another configuration example, the constituent elements of two or more pixels may be provided in a single cell.

In this instance, the shapes of the regions (cells) may be various shapes. For example, the shape of a single cell when the normal direction of the pixel substrate 61 is viewed as a visual line, may be square, rectangular, triangular, a pentagonal or more polygonal shape, or the like. In addition, the number of the partitioning walls that partition a single cell may be various numbers.

In addition, in the present embodiment, a configuration that includes the dispersion medium 41, and the electrophoretic particles 42 and 43 is shown. As another configuration example, the number of types of electrophoretic particles may be a single type, of may be three types or more. In addition, the color of each electrophoretic particle nay be arbitrary.

In addition, in the present embodiment, the insulation layer 63 is provided on the pixel substrate section 21, but as other configuration examples, the insulation layer 63 need not be provided, a layer of another material may be provided in place of the insulation layer 63.

### Second Embodiment

FIG. 3 is a cross-sectional view that shows a schematic configuration example of an electrophoretic display device 101 according to an embodiment (the second embodiment) of the invention.

The electrophoretic display device 101 is provided with a pixel substrate section 111, a counter substrate section 112, and partitioning walls 113 and 114.

In this instance, FIG. 3 outlines a cross-sectional view of the electrophoretic display device 101 in the same manner as FIG. 2.

When compared with the electrophoretic display device 11 that is shown in FIGS. 1A, 1B and 2, the configuration of the partitioning walls 113 and 114 of the electrophoretic display device 101 according to the present embodiment is different, and the configurations of other portions are the same.

In FIG. 3, a cross-sectional view in which a cell that is partitioned by the partitioning wall 113, the partitioning wall 114, and other partitioning walls (not illustrated in the drawing), is shown with the corresponding partitioning wall 113 and the corresponding partitioning wall 114, which face one another, viewed from a lateral surface direction. In addition, images of the flow of the dispersion liquid are shown with arrows.

As shown in FIG. 3, in the present embodiment, the inner surface (a surface that faces the inner section of the cell) of only one of the two partitioning walls 113 and 114 (only the partitioning wall 114 in example of FIG. 3), which face one another, is inclined with respect to a normal direction of the pixel substrate section 111 (a normal direction of the pixel substrate). The inner surface of the other partitioning wall (the partitioning wall 113 in example of FIG. 3) is flat in the corresponding normal direction.

In the abovementioned manner, in the electrophoretic display device 101 according to the present embodiment, it is possible to realize smooth movement of the electrophoretic particles in regions (cells) that are partitioned the partitioning walls 113 and 114 formed between two substrates.

Additionally, in the present embodiment, press imprinting using a metallic mold may be used. For example, as a result of transfer using a metallic mold, it is possible to easily create a partitioning wall shape that is inclined in an optimal manner for flow.

### Third Embodiment

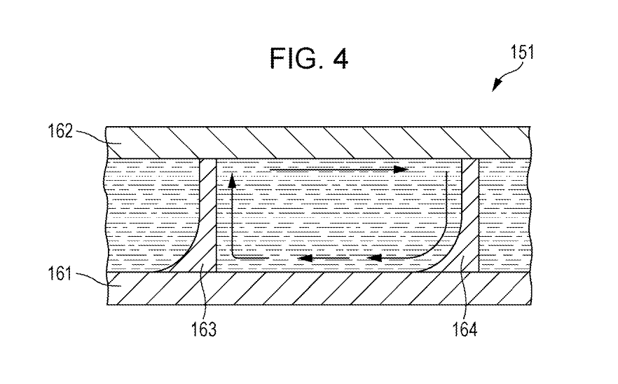

FIG. 4 is a cross-sectional view that shows a schematic configuration example of an electrophoretic display device 151 according to an embodiment (the third embodiment) of the invention.

The electrophoretic display device 151 is provided with a pixel substrate section 161, a counter substrate section 162, and partitioning walls 163 and 164.

In this instance, FIG. 4 outlines a cross-sectional view of the electrophoretic display device 151 in the same manner as FIG. 2.

When compared with the electrophoretic display device 11 that is shown in FIGS. 1A, 1B and 2, the configuration of the partitioning walls 163 and 164 of the electrophoretic display device 151 according to the present embodiment is different, and the configurations of other portions are the same.

In FIG. 4, a cross-sectional view in which a cell that is partitioned by the partitioning wall 163, the partitioning wall 164, and other partitioning walls (not illustrated in the drawing), is shown with the corresponding partitioning wall 163 and the corresponding partitioning wall 164, which face one another, viewed from a lateral surface direction. In addition, images of the flow of the dispersion liquid are shown with arrows.

As shown in FIG. 4, in the present embodiment, the inner surface (a surface that faces the inner section of the cell) of only one of the two partitioning walls 163 and 164 (only the partitioning wall 164 in example of FIG. 4), which face one another, is inclined with respect to a normal direction of the pixel substrate section 161 (a normal direction of the pixel substrate). In the present embodiment, the corresponding inclination is provided on a side of the pixel substrate section 161, and on a side of the counter substrate section 162, the corresponding inner surface is flat in the corresponding normal direction. In the present embodiment, by forming a shape that is curved to a side of the pixel substrate section 161 on the inner surface of the partitioning wall 164 (a bottom section in the example of FIG. 4), it is possible to facilitate flow of the dispersion liquid. The shape that is curved is, for example, an arc shape. In this manner, in particular, there are cases in which it is preferable that a border of a boundary section between a partitioning wall (the partitioning wall 163 or the partitioning wall 164), and a substrate section (the pixel substrate section 161 or the counter substrate section 162) is a shape with a curved line (a curve) that is larger than a right angle.

In the abovementioned manner, in the electrophoretic display device 151 according to the present embodiment, it is possible to realize smooth movement of the electrophoretic particles in regions (cells) that are partitioned the partitioning walls 163 and 164 formed between two substrates.

Additionally, in the present embodiment, press imprinting using a metallic mold may be used. For example, as a result of transfer using a metallic mold, it is possible to easily create a partitioning wall shape that is inclined in an optimal manner for flow.

### Fourth Embodiment

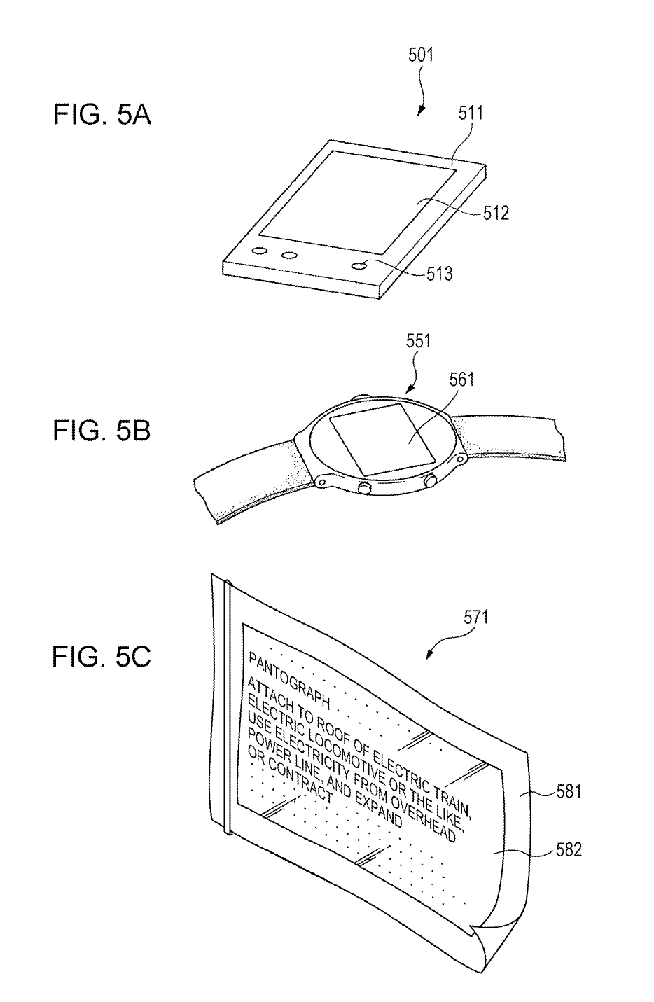

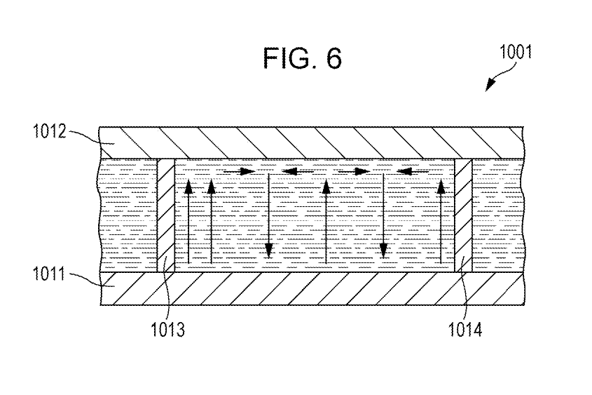

FIGS. 5A to 5C are views that show schematic configuration examples of electronic apparatuses according to an embodiment of the invention. In the present embodiment, specific examples of electronic apparatuses in which an electrophoretic display device (any one of the electrophoretic display devices 11, 101 and 151 according to the first embodiment to the third embodiment) according to the abovementioned embodiments is applied, are shown.

FIG. 5A is a perspective view that shows an electronic book 501, which is an example of an electronic apparatus.

The electronic book 501 is provided with a book-shaped frame 511, a display section 512 in which an electrophoretic display device according to the abovementioned embodiments is applied, and an operation section 513.

FIG. 5B is a perspective view that shows a wristwatch 551, which is an example of an electronic apparatus.

The wristwatch 551 is provided with a display section 561 in which an electrophoretic display device according to the abovementioned embodiments is applied.

FIG. 5C is a perspective view that shows electronic paper 571, which is an example of an electronic apparatus.

The electronic paper 571 is provided with a main body section 581, which is configured by a rewritable sheet having a similar texture and flexibility to paper, and a display section 582 in which an electrophoretic display device according to the abovementioned embodiments is applied.

Additionally, the electrophoretic display devices according to the abovementioned embodiments may be applied to various other electronic apparatuses, and for example, may be applied to mobile telephones, display sections of electronic apparatuses such as portable audio equipment, commercial sheets such as manuals, textbooks, exercise books, information sheets and the like.

In the abovementioned manner, in the electronic apparatus according to the present embodiment, it is possible to obtain the same effects as those of the electrophoretic display devices according to the abovementioned embodiments.

### Various Configuration Examples of Partitioning Walls of Electrophoretic Display Device

The configuration of the partitioning walls of the electrophoretic display device may be the configurations that are illustrated by way of example in the abovementioned embodiments, or may be other configurations.

For example, the inner surfaces (surface that face an inner section of the cell) of a plurality of partitioning walls that partition a single region (cell) are provided with shapes that cause a flow of the dispersion liquid in a single direction to be generated along a surface of a side of a first substrate, an inner surface of a first partitioning wall, a surface of a side of a second substrate, and an inner surface of a second partitioning wall in the inner section of the corresponding cell.

In the electrophoretic display device according to a configuration example, the partitioning walls are provided between a first substrate and a second substrate, and the dispersion liquid is disposed in regions (cells) that are partitioned by the partitioning walls. The dispersion liquid includes a dispersion medium and electrophoretic particles. Surfaces (inner surfaces of the partitioning walls) of partitioning walls on the sides of the regions (cells) include inclined sections, which are inclined with respect to a normal direction of the first substrate. However, a predetermined configuration is not included.

The corresponding predetermined configuration is a configuration in which the surfaces of the partitioning walls on the sides of the regions (cells) of portions that respectively correspond to all of a plurality of edges that intersecting lines between the surfaces (inner surfaces of the partitioning walls) of the partitioning walls on the sides of the regions (cells) and surfaces (surfaces of a first substrate section) of first substrate sides thereof, form, include inclined sections with the same inclination direction and the same inclination angle. In other words, in a case in which all of the partitioning walls that partition a cell, have the same inclination direction and the same inclination angle, even if there is inclination, since the inclination of each edge is equivalent when viewed from an inner section of the cell, and there are no differences, the corresponding predetermined configuration is not included.

In the electrophoretic display device according to the present configuration example, it is possible to generate asymmetrical flow of the dispersion liquid as a result of the inclined sections.

In this instance, as an example, the first substrate is a pixel substrate, the first substrate section is a pixel substrate section, and the second substrate is a counter substrate. As another example, the first substrate is a counter substrate, the first substrate section is a counter substrate section, and the second substrate is a pixel substrate.

In the electrophoretic display device according to a configuration example, the partitioning walls are provided between a first substrate and a second substrate, and the dispersion liquid is disposed in regions (cells) that are partitioned by the partitioning walls. The dispersion liquid includes a dispersion medium and electrophoretic particles. Surfaces (inner surfaces of the partitioning walls) of partitioning walls on the sides of the regions (cells) include inclined sections, which are inclined with respect to a normal direction of the first substrate. Further, the surfaces (inner surfaces of the partitioning walls) of the partitioning walls on the sides of the regions (cells) are not symmetrical when rotated by two or more different angles with respect to an axis of the normal direction of the first substrate. In other words, a configuration in which, in a case in which an axis of the normal direction of the first substrate is taken as the center of the surfaces (for example, rectangles or the like) of a parallel cell on the first substrate, the cell is the same shape (is symmetrical) when rotated around the corresponding axis by a first angle (for example, 90°, 45° or the like), and the cell is the same shape (is symmetrical) when rotated around the corresponding axis by a second angle (for example, 180°, 90° or the like), is not included.

In the electrophoretic display device according to the present configuration example, it is possible to generate asymmetrical flow of the dispersion liquid as a result of the inclined sections.

In this instance, as an example, the first substrate is a pixel substrate, the first substrate section is a pixel substrate section, and the second substrate is a counter substrate. As another example, the first substrate is a counter substrate, the first substrate section is a counter substrate section, and the second substrate is a pixel substrate.

In the electrophoretic display device according to a configuration example, the partitioning walls are provided between a first substrate and a second substrate, and the dispersion liquid is disposed in regions (cells) that are partitioned by the partitioning walls. The dispersion liquid includes a dispersion medium and electrophoretic particles. Surfaces (inner surfaces of the partitioning walls) of partitioning walls on the sides of the regions (cells) include inclined sections, which are inclined with respect to a normal direction of the first substrate. Further, the surfaces (inner surfaces of the partitioning walls) of the partitioning walls on the sides of the regions (cells) of portions that correspond to only a single edge among the plurality of edges that intersecting lines between the surfaces (inner surfaces of the partitioning walls) of the partitioning walls on the sides of the regions (cells) and the surfaces (surfaces of a first substrate section) of first substrate sides thereof, form, include the inclined sections. In other words, for example, in a case in which a cell is partitioned by a plurality of partitioning walls, only a single partitioning wall has an inclined section.

In the electrophoretic display device according to the present configuration example, it is possible to generate asymmetrical flow of the dispersion liquid as a result of the inclined sections.

In this instance, as an example, the first substrate is a pixel substrate, the first substrate section is a pixel substrate section, and the second substrate is a counter substrate. As another example, the first substrate is a counter substrate, the first substrate section is a counter substrate section, and the second substrate is a pixel substrate.

In the electrophoretic display device according to a configuration example, the partitioning walls are provided between a first substrate and a second substrate, and the dispersion liquid is disposed in regions (cells) that are partitioned by the partitioning walls. The dispersion liquid includes a dispersion medium and electrophoretic particles. Surfaces (inner surfaces of the partitioning walls) of partitioning walls on the sides of the regions (cells) include inclined sections, which are inclined with respect to a normal direction of the first substrate. However, this is a configuration in which the surfaces (inner surfaces of the partitioning walls) of the partitioning walls on the sides of the regions (cells) of portions that correspond to two mutually parallel edges among the plurality of edges that intersecting lines between the surfaces (inner surfaces of the partitioning walls) of the partitioning walls on the sides of the regions (cells) and the surfaces (surfaces of a first substrate section) of first substrate sides thereof, form, both have a configuration that includes the inclined sections, and is not a configuration in which the inclination directions of the inclined sections, which include the respective edges, with respect to surfaces that are parallel to the normal direction of the first substrate, are opposite, and the inclination angles thereof are the same. In other words, a case in which, for example, two partitioning walls, which face one another, include inclined sections with mutually opposite inclination directions and the same inclination angle, is not included.

In the electrophoretic display device according to the present configuration example, it is possible to generate asymmetrical flow of the dispersion liquid as a result of the inclined sections.

In this instance, as an example, the first substrate is a pixel substrate, the first substrate section is a pixel substrate section, and the second substrate is a counter substrate. As another example, the first substrate is a counter substrate, the first substrate section is a counter substrate section, and the second substrate is a pixel substrate.

In the electrophoretic display device according to a configuration example, the partitioning walls are provided between a first substrate and a second substrate, and the dispersion liquid is disposed in regions (cells) that are partitioned by the partitioning walls. The dispersion liquid includes a dispersion medium and electrophoretic particles. Surfaces (inner surfaces of the partitioning walls) of partitioning walls on the sides of the regions (cells) include inclined sections, which are inclined with respect to a normal direction of the first substrate. Further, this is a configuration in which the surfaces (inner surfaces of the partitioning walls) of the partitioning walls on the sides of the regions (cells) of portions that correspond to two mutually parallel edges among the plurality of edges that intersecting lines between the surfaces (inner surfaces of the partitioning walls) of the partitioning walls on the sides of the regions (cells) and the surfaces (surfaces of a first substrate section) of first substrate sides thereof, form, both include the inclined sections, and is a configuration in which the inclination directions and inclination angles of the inclined sections, which include the respective edges, with respect to surfaces that are parallel to the normal direction of the first substrate, are the same. In other words, for example, is a configuration of a case that is shown in FIGS. 1A, 1B and 2.

In the electrophoretic display device according to the present configuration example, it is possible to generate asymmetrical flow of the dispersion liquid as a result of the inclined sections.

In this instance, as an example, the first substrate is a pixel substrate, the first substrate section is a pixel substrate section, and the second substrate is a counter substrate. As another example, the first substrate is a counter substrate, the first substrate section is a counter substrate section, and the second substrate is a pixel substrate.

As a configuration example, the plurality of edges mentioned above form polygonal edges. In other words, for example, is a configuration of a case that is shown in FIGS. 1A, 1B and 2, FIG. 3 or FIG. 4.

As a configuration example, the surfaces (surfaces of the partitioning walls) of the partitioning walls on the sides of the regions (cells) of portions that correspond to two mutually parallel edges among the plurality of edges, are flat surfaces. In other words, for example, is a configuration of a case that is shown in FIGS. 1A, 1B and 2, or FIG. 3.

As another configuration example, the surfaces (surfaces of the partitioning walls) of the partitioning walls on the sides of the regions (cells) of portions that correspond to two mutually parallel edges among the plurality of edges, are surfaces that include curved sections (an example of an inclined section). In other words, for example, is a configuration of a case that is shown in FIG. 4.

Additionally, in the abovementioned description, in particular, specific examples of cases in which, among the plurality of partitioning walls that partition a single region (cell), as shown in the examples in FIGS. 2 to 4, a relationship of the shapes (shapes that include a three-dimensional disposition with respect to the first substrate) of two partitioning walls that face one another is set to a characteristic configuration, are shown. As another configuration example, the relationship of the shapes of two partitioning walls that do not face one another may be set to a characteristic configuration. The corresponding two partitioning walls may, for example, be two adjacent partitioning walls, or may be two partitioning walls that are not adjacent.

Each configuration that is illustrated by way of example in FIGS. 2 to 4, for example, is an example in which the structure of the partitioning walls can be easily created.

Embodiments of the invention have been described in detail above with reference to the drawings, but the specific configuration is not limited to the embodiments, and also includes designs and the like of a range that does not depart from the scope of the invention.

The entire disclosure of Japanese Patent Application No. 2015-071560, filed Mar. 31, 2015 is expressly incorporated by reference herein.

What is claimed is:

1. An electrophoretic display device,
wherein partitioning wall is provided between a first substrate and a second substrate,
wherein a dispersion liquid is disposed in region that is partitioned by the partitioning wall,
wherein the dispersion liquid includes a dispersion medium and electrophoretic particle, and
wherein surface of partitioning wall on side of the region include inclined section, which is inclined with respect to a normal direction of the first substrate, and do not have a configuration in which the surface of the partitioning wall on the side of the region of portions that respectively correspond to all of a plurality of edges that intersecting lines between the surface of the partitioning wall on the side of the region and surface of first substrate side thereof, form, include inclined section with the same inclination direction and the same inclination angle.

2. The electrophoretic display device according to claim 1,
wherein the surfaces of the partitioning wall on the side of the region is not symmetrical when rotated by two or more different angles with respect to an axis of the normal direction of the first substrate.

3. The electrophoretic display device according to claim 1,
wherein the surfaces of the partitioning wall on the side of the region of portions that correspond to only a single edge among the plurality of edges that intersecting lines between the surfaces of the partitioning wall on the side of the region and the surfaces of first substrate side thereof, form, include the inclined section.

4. The electrophoretic display device according to claim 1,
wherein the surfaces of the partitioning wall on the side of the region of portions that correspond to two mutually parallel edges among the plurality of edges that intersecting lines between the surfaces of the partitioning wall on the side of the region and the surfaces of first substrate side thereof, form, both have a configuration that includes the inclined section, and do not have a configuration in which the inclination directions of the inclined section, which include the respective edges, with respect to surfaces that are parallel to the normal direction of the first substrate, are opposite, and the inclination angles thereof are the same.

5. The electrophoretic display device according to claim 4,
wherein the surfaces of the partitioning wall on the side of the region of portions that correspond to two mutually parallel edges among the plurality of edges, both have a configuration that includes the inclined section, and have a configuration in which the inclination directions and inclination angles of the inclined section, which include the respective edges, with respect to surfaces that are parallel to the normal direction of the first substrate, are the same.

6. The electrophoretic display device according to claim 4,
wherein the plurality of edges form polygonal edges.

7. The electrophoretic display device according to claim 4,
wherein the surfaces of the partitioning wall on the side of the region of portions that correspond to two mutually parallel edges among the plurality of edges, are flat surfaces.

8. The electrophoretic display device according to claim 4,
wherein the surfaces of the partitioning wall on the side of the region of portions that correspond to two mutually parallel edges among the plurality of edges, are surfaces that include curved section.

9. An electronic apparatus comprising:
the electrophoretic display device according to claim 1.

10. An electronic apparatus comprising:
the electrophoretic display device according to claim 2.

11. An electronic apparatus comprising:
the electrophoretic display device according to claim 3.

12. An electronic apparatus comprising:
the electrophoretic display device according to claim 4.

13. An electronic apparatus comprising:
the electrophoretic display device according to claim 5.

14. An electronic apparatus comprising:
the electrophoretic display device according to claim 6.

15. An electronic apparatus comprising:
the electrophoretic display device according to claim 7.

16. An electronic apparatus comprising:
the electrophoretic display device according to claim 8.
